(19) United States
(12) Patent Application Publication
(10) Pub. No.: US 2017/0337098 A1
(43) Pub. Date: Nov. 23, 2017

(54) CLOUD DEVICE, TERMINAL DEVICE, AND METHOD FOR HANDLING ABNORMALITIES THEREIN

(71) Applicant: Chiun Mai Communication Systems, Inc., New Taipei (TW)

(72) Inventor: WEI-LI LU, New Taipei (TW)

(21) Appl. No.: 15/593,308

(22) Filed: May 11, 2017

(30) Foreign Application Priority Data
May 19, 2016 (CN) 201610338694.9

(51) Int. Cl. G06F 11/07; G06F 3/147

(52) U.S. Cl. CPC G06F 11/0709; G06F 11/0793; G06F 11/0784; G06F 3/147

(57) ABSTRACT

A cloud device, a terminal device, and a method for handling abnormalities are disclosed. The method includes: detecting a running state of the terminal device and operations carried out by the user of the terminal device; transmitting data as to the detections to the cloud device; the cloud device determining whether an abnormality exists in the terminal device, and generating an analysis report to provide a method and/or a program to fix the abnormality for the user. The method further includes the optional detection of potential abnormalities in addition to actual abnormalities, and obtaining operational habits of the user according to his operations, and optimizing the terminal device accordingly.

### CROSS-REFERENCE TO RELATED APPLICATIONS

This application claims priority to Chinese Patent Application No. 201610338694.9 filed on May 19, 2016.

### FIELD

The subject matter herein generally relates to communication technology, and particularly to a cloud device, a terminal device, and a method for handing abnormalities therein.

### BACKGROUND

When using an electronic device, abnormalities often occur. Users may do not know how to solve the abnormality.

### BRIEF DESCRIPTION OF THE DRAWINGS

Implementations of the present technology will now be described, by way of example only, with reference to the attached figures.

FIG. 1 is a block diagram illustrating an exemplary embodiment of an operating environment of a cloud device and a terminal device.

FIG. 2 is a block diagram illustrating an exemplary embodiment of a terminal device.

FIG. 3 is a block diagram illustrating an exemplary embodiment of a cloud device.

FIG. 4 is a schematic view illustrating an exemplary embodiment of a prompting window displayed in the terminal device of FIG. 2.

FIGS. 5A-5B are flowcharts illustrating an exemplary embodiment of method for handling abnormalities based on cloud service.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

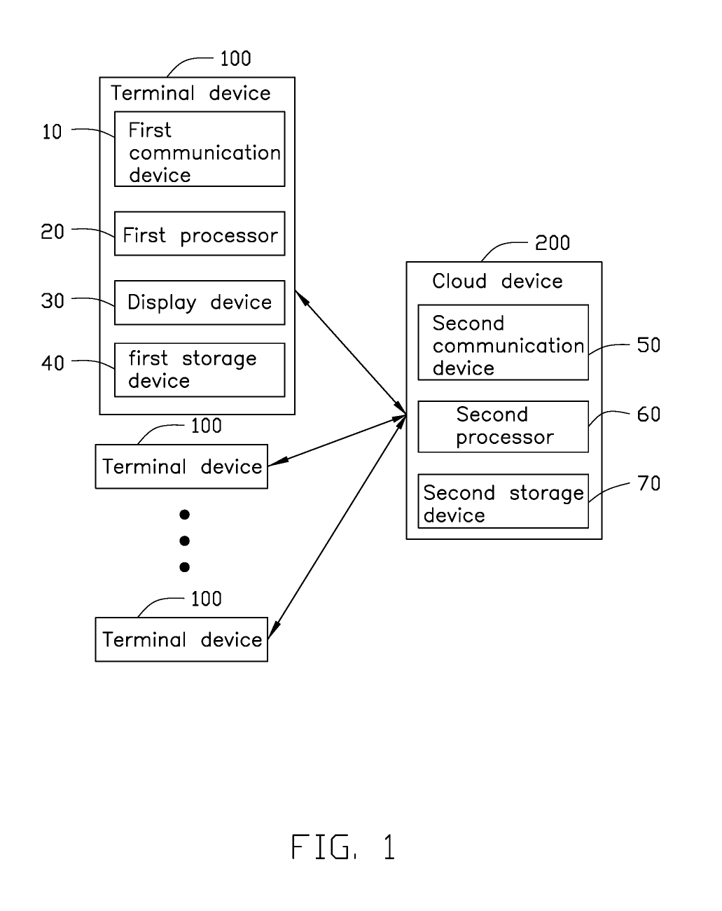

FIG. 1 illustrates an exemplary embodiment of an operating environment of at least one terminal device 100 and at least one cloud device 200. In the exemplary embodiment, the at least one cloud device 200 communicates with at least one terminal device 100. In the exemplary embodiment, the at least one terminal device 100 can be, but is not limited to, a smart phone, a tablet, or the like. The at least one cloud device 200 can be, but is not limited to, a cloud server, a cloud server cluster, or the like.

In the exemplary embodiment, the at least one terminal device 100 can include, but is not limited to, a first communication device 10, a first processor 20, a display device 30, and a first storage device 40. The first communication device 10 can establish a communication with the at least one cloud device 200 wirelessly or by wires. In the exemplary embodiment, the first communication device 10 can be, but are not limited to, a BLUETOOTH module, a WI-FI module, or a ZIGBEE module. The first processor 20 can be, but is not limited to, a central processing unit, a digital signal processor, or a single chip, for example. The display device 30 can be, but is not limited to, a touch input screen. The first storage device 40 can be, but is not limited to, an internal storage system, such as a flash memory, a random access memory (RAM) for temporary storage of information, and/or a read-only memory (ROM) for permanent storage of information. The first storage device 40 can also be a storage system, such as a hard disk, a storage card, or a data storage medium.

In the exemplary embodiment, the at least one cloud device 200 can include, but is not limited to, a second communication device 50, a second processor 60, and a second storage device 70. The at least one cloud device 200 communicates with the at least one terminal device 100 through the second communication device 50. In the exemplary embodiment, the second communication device 50 can be, but are not limited to, a BLUETOOTH module, a WI-FI module, or a ZIGBEE module. The second processor 60, can be, but is not limited to, a central processing unit, a digital signal processor, or a single chip, for example. The second storage device 70 can be, but is not limited to, an internal storage system, such as a flash memory, a random access memory (RAM) for temporary storage of information, and/or a read-only memory (ROM) for permanent storage of information. The second storage device 70 can also be a storage system, such as a hard disk, a storage card, or a data storage medium.

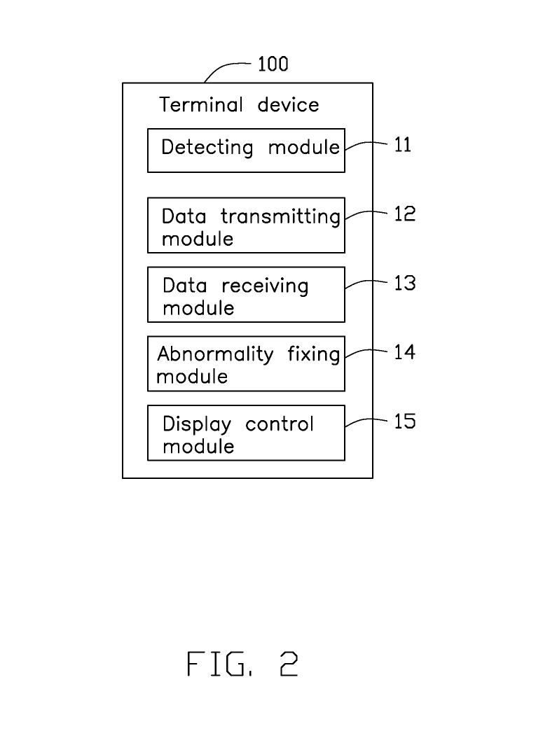

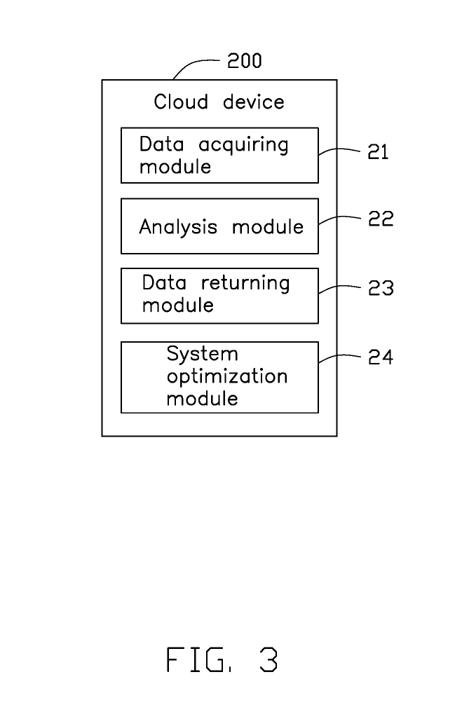

Referring to FIG. 2, the first storage device 40 stores a number of modules, which are a collection of software instructions which can be executed by the first processor 20. In the exemplary embodiment, the modules can include a detecting module 11, a data transmitting module 12, a data receiving module 13, and an abnormality fixing module 14. Referring to FIG. 3, the second storage device 70 stores a number of modules, which are a collection of software instructions executed by the second processor 60. In the exemplary embodiment, the modules can include a data acquiring module 21, an analysis module 22, and a data returning module 23.

The detecting module 11 detects a running state of the terminal device 100 and detects process of an operation carried out by a user when the user operates the terminal device 100.

In the exemplary embodiment, the detecting module 11 can detect the running state of the terminal device 100 and the process of the operation by detecting the running state of at least one interior component 101 of the terminal device 100, and user operations applied to the at least one interior component 101. The at least one interior component can be, but is not limited to, one or more of a touch screen (not shown), a sensor (not shown), applications, an operation system, function modules, and physical buttons. For example, the sensor can be an acceleration sensor, the detecting module 11 can detect therefrom an operation process of shaking the terminal device 100. The applications can be, but are not limited to, a calculator, a instant messaging tool, or other applications running in the terminal device. The detecting module 11 can detect running states such as crash or flash back of the terminal device 100 by detecting a running state of the applications, such as the calculator, or the instant messaging tool. The detecting module 11 further can detect the operation process of the user by detecting whether applications are opened and closed repeatedly. The function modules can be, but are not limited to, a WIFI module, a BLUETOOTH module, and/or a GPS (global positioning system) module. The detecting module 11 detects a running state of the terminal device 100 by detecting the network connection state of the WIFI module, the BLUETOOH module and/or the GPS module. The detecting module 11 further can detect the operation process of the user by detecting whether the function modules are opened and closed repeatedly. In the exemplary embodiment, the detecting module 11 further can detect the operation process of the user by detecting whether physical buttons are pressed.

In the exemplary embodiment, the detecting module 10 further stores the running state of the terminal device 100 and the operation process of the user to the first storage device 40. In the exemplary embodiment, the detecting module 10 stores the running state and the operation process of a most recent period, for example the most recent 30 minutes.

In the exemplary embodiment, the detecting module 10 records the running state of the terminal device 100 and the operation process of the user in a log file.

The data transmitting module 12 transmits the running state of the terminal device 100 and the process of the operation detected by the detecting module 11 to the cloud device 200, through the first communication device 10.

The data acquiring module 22 acquires the running state of the terminal device 100 and the operation process of the user from the terminal device 100.

The analysis module 22 determines whether an abnormality occurs in the terminal device 100 by analyzing the running state of the terminal device 100 and the process of the operation. In the exemplary embodiment, the second storage device 70 stores a first database recording data as to abnormalities. The abnormality data can include running state data representing abnormality states of the terminal device 100, operation process data representing abnormality states of the terminal device 100, and type of abnormality of each running state data and each operation process data stored in the first database. The analysis module 22 compares the acquired running state of the terminal device 100 and the operation process with the abnormality data stored in the first database, and determines that an abnormality occurs in the terminal device 100 if one or more of the running states of the terminal device 100 and the operation processes match with the one of the data as to abnormalities in the first database.

The analysis module 22 further determines a type of the abnormality according to the first database, and generates an analysis report if the analysis module 22 determines that an abnormality occurs in the terminal device 100. In the exemplary embodiment, the second storage device 70 further stores a second database recording a number of analysis reports, each analysis report corresponds to one type of abnormality. The analysis module 22 generates the analysis report according to the abnormality type of the abnormality and the second database. In the exemplary embodiment, the analysis report can include, but is not limited to, a suggestion for fixing the abnormality and/or a program for fixing the abnormality. In the exemplary embodiment, the suggestion can include, but is not limited to, re-downloading applications and providing the user with a download link, or providing the user with an operation method to avoid the abnormality.

The data returning module 23 transmits the analysis report generated by the analysis module 22 to the terminal device 100 by using the second communication device 50.

The data receiving module 13 of the terminal device 100 receives the analysis report transmitted by the data returning module 23 of the cloud device 200.

The abnormality repairing module 14 fixes the abnormality according to the analysis report received from the cloud device 200.

In a second exemplary embodiment, when the analysis module 22 determines an abnormality in the terminal device 100, the analysis module 22 determines the type of the abnormality and generates a prompt message according to the abnormality type. The prompt message is used to prompt the user to confirm whether the abnormality is actually a false positive or misreading. In the second embodiment, the prompt message can be, but is not limited to, text, or voice message. For example, the content of the prompt message can be: “An abnormality of the WIFI module of your phone is detected, please indicate whether this apparent abnormality is an actual abnormality”.

The data returning module 23 transmits the prompt message to the terminal device 100 by using the second communication device 50.

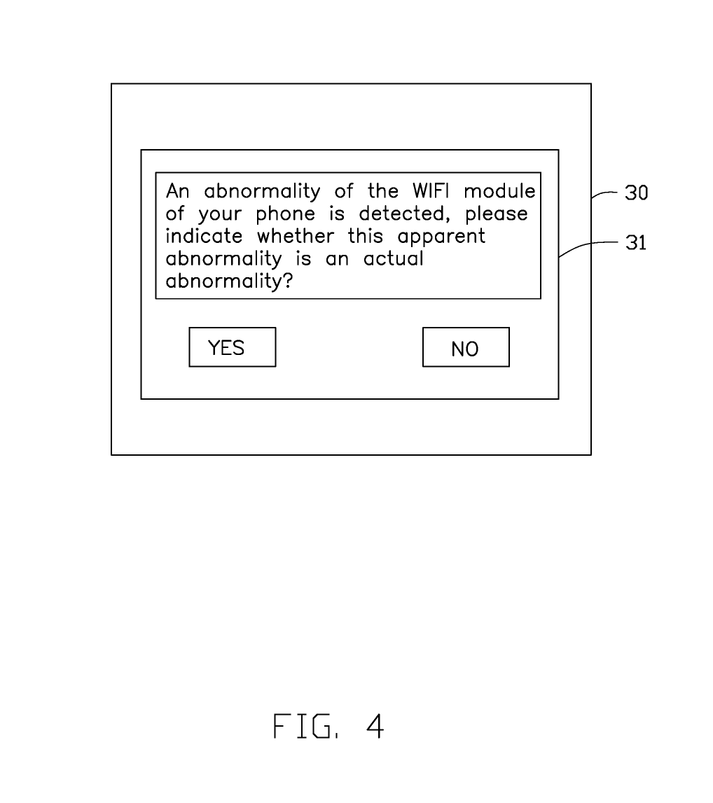

In the second exemplary embodiment, the modules stored in the first storage device 40 further includes a display control module 15. When receiving the prompt message from the cloud device 200, the display control module 15 controls the display device 30 to display a prompting window 31 to display the prompt message. For example, the prompting window 31 can include a text box to display the content of the prompt message, see FIG. 4, the content displayed in the text box can be “An abnormality of the WIFI module of your phone is detected, please indicate whether this apparent abnormality is an actual abnormality”. The prompting window 31 further can include confirm and deny buttons “YES” and “NO”. If the user determines that the abnormality exists, the user can click the confirm button “YES”. If the user determines that the abnormality is a misreading, the user can click the deny button “NO”. It can be understood that the prompting window 31 is not limited to being the text box, for example, the prompting window further can be a voice playback window configured to playback a voice prompt message.

The display control module 15 further determines a confirm information according to the user's selection, and transmits the confirm information to the cloud device 200 through the first communication device 10. For example, if the user selects the confirm button “YES”, the display control module 15 determines that the apparent abnormality is in fact an abnormality. If the user selects the deny button “NO”, the display control module 15 determines that the apparent abnormality is a misreading.

The analysis module 22 acquires the deny information. If the analysis module 22 determines that the deny information indicates a misreading, the analysis module 22 stores the misreading event to the second storage device 70, and stores the running state of the terminal device 100 and the process of the operation corresponding to the misreading event to the second storage device 70. If the analysis module 22 determines that the confirm information indicates an actual abnormality, the analysis module 22 generates the analysis report and transmits the analysis report to the terminal device 100.

The display control module 15 further controls the display device 30 to display the analysis report.

In the exemplary embodiment, the cloud device 200 further includes a system optimization module 24. The system optimization module 24 collects the process of the operation carried by the user to obtain operational habits of the user, and optimizes the terminal device 100 according to the same. For example, the system optimization module 24 collects the operation process of the user to determine which applications or function modules are rarely used by the user, and hides such rarely used applications or function modules to optimize the user interface of the terminal device 100. For another example, the system optimization module 24 collects the operation process of the user and determines that one or more key combinations are frequently used incorrectly, the system optimization module 24 may prompt a designer of the terminal device 100 to redesign the physical keys of the terminal device 100.

It can be understood that the system optimization module 24 further can be applied in the terminal device 100.

In the exemplary embodiment, after determining that an abnormality exists in the terminal device 100, the analysis module 22 further automatically detects potential abnormalities of the terminal device 100. In the exemplary embodiment, the analysis module 22 asks the user to operate the terminal devices 100 in a specified way, the analysis module 22 detects potential abnormalities according to the running state of the terminal device 100 when the terminal device 100 is operated by the user. For example, the analysis module 22 asks the user to open and close the WIFI module, and detects potential abnormalities by detecting whether the WIFI module responds correctly to the user's command. If the WIFI module responds correctly to the user's command, the analysis module 22 determines that there is not a potential abnormality. Otherwise, the analysis module 22 determines that there is a potential abnormality of the WIFI module. In other embodiments, the analysis module 22 further can detect the potential abnormality by using existing technology.

In the exemplary embodiment, the analysis module 22 further generates a detecting prompt before detecting the potential abnormalities, and transmits the detecting prompt to the terminal device 100. The detecting prompt is configured to prompt the user whether to detect a potential abnormality. For example, the content of the detecting prompt can be that “In future, do you agree to detect not only existing and actual abnormalities, but also any potential abnormalities?”

The display control module 15 receives the detecting prompt and controls the display device 30 to display a window to display the detecting prompt. The display window further can include two buttons “YES” and “NO” for confirmation and denial. If the user agrees to detect the potential abnormalities, the user can click the “YES” button, and the analysis module 22 will detect the potential abnormalities in response to the user's selection. Otherwise, the user can click the “NO” button, and the analysis module 22 will not detect any potential abnormalities.

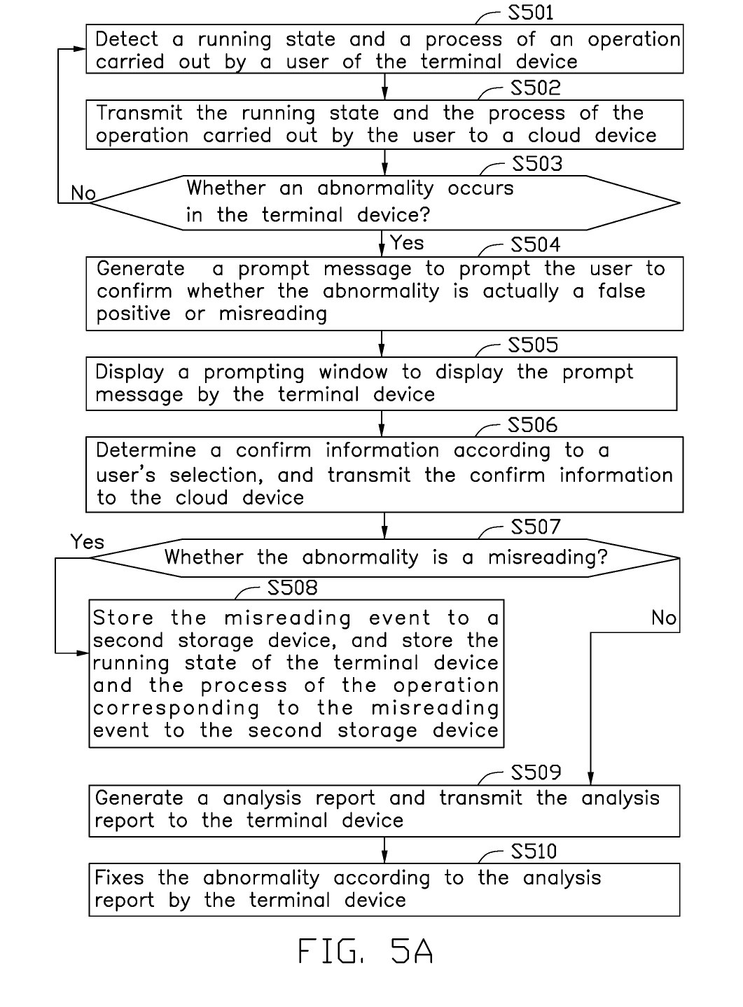

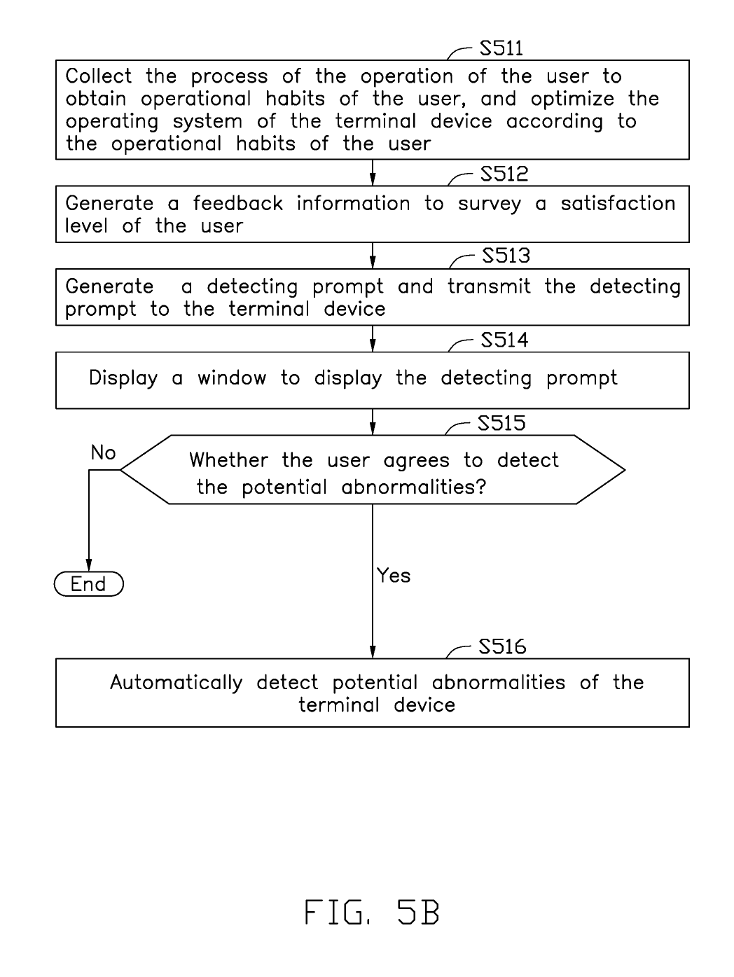

A method for handling abnormalities is indicated in FIG. 5A-5B. The method is provided by way of example, as there are a variety of ways to carry out the method. Each block shown in FIG. 5A-5B represents one or more processes, methods, or subroutines carried out in the example method. Additionally, the illustrated order of blocks is by example only and the order of the blocks can be changed. The example method can begin at block S501.

At block S501, a terminal device detects its running state and a process of an operation carried out by a user of the terminal device.

At block S502, the terminal device transmits the running state and the process of the operation carried out by the user to a cloud device.

At block S503, the cloud device acquires the running state of the terminal device and the process of the operation from the terminal device, and determines whether an abnormality occurs in the terminal device by analyzing the running state of the terminal device and the process of the operation. If the cloud device determines that an abnormality occurs in the terminal device, the procedure goes to block S504, otherwise, the procedure goes back to block S501.

In the exemplary embodiment, the cloud device stores a first database recording data as to abnormalities. The abnormality data can include running state data representing abnormality states of the terminal device, operation process data representing abnormality states of the terminal device, and type of abnormality of each running state data and each operation process data stored in the first database. The cloud device compares the acquired running state of the terminal device and the operation process with the abnormality data stored in the first database, and determines that an abnormality occurs in the terminal device if one or more of the running states of the terminal device and the operation processes match with the one of the data as to abnormalities data in the first database.

At block S504, when determining that the abnormality is occur in the terminal device, the cloud device generates a prompt message to prompt the user to confirm whether the abnormality is actually a false positive or misreading, and transmits the prompt message to the terminal device.

At block S505, the terminal device displays a prompting window to display the prompt message. The prompting window 31 further can include confirm and deny buttons “YES” and “NO”. If the user determines that the abnormality exists, the user can click the confirm button “YES”. If the user determines that the abnormality is a misreading, the user can click the deny button “NO”.

At block S506, the terminal device determines a confirm information according to the user's selection, and transmits the confirm information to the cloud device.

At block S507, the cloud device acquires the deny information and determines whether the abnormality is a misreading. If the abnormality is a misreading, the procedure goes to block S508, otherwise, the procedure goes to block S509.

At block S508, the cloud device stores the misreading event to a second storage device, and stores the running state of the terminal device and the process of the operation corresponding to the misreading event to the second storage device.

At block S509, the cloud device generates a analysis report and transmits the analysis report to the terminal device. In the exemplary embodiment, the second storage device further stores a second database recording a number of analysis reports, each analysis report corresponds to one type of abnormality. The cloud device generates the analysis report according to the abnormality type of the abnormality and the second database. In the exemplary embodiment, the analysis report can include, but is not limited to, a suggestion for fixing the abnormality and/or a program for fixing the abnormality. In the exemplary embodiment, the suggestion can include, but is not limited to, re-downloading applications and providing the user with a download link, or providing the user with an operation method to avoid the abnormality.

At block S510, the terminal device receives the analysis report transmitted by the cloud device, and fixes the abnormality according to the analysis report received from the cloud device.

In an alternative embodiment, the block S504-S508 can be omitted.

In at least one exemplary embodiment, the method further can include a block S511: the cloud device collects the process of the operation of the user to obtain operational habits of the user, and optimizes the operating system of the terminal device according to the operational habits of the user.

In the exemplary embodiment, the method further can include a block S512: the cloud device generates a feedback information to survey a satisfaction level of the user.

In the exemplary embodiment, the method further can include:

At block S513, the cloud device generates a detecting prompt and transmits the detecting prompt to the terminal device. The detecting prompt is configured to prompt the user whether to detect a potential abnormality. For example, the content of the detecting prompt can be that “In future, do you agree to detect not only existing and actual abnormalities, but also any potential abnormalities?”

At block S514, the terminal device receives the detecting prompt and displays a window to display the detecting prompt. The display window further can include two buttons “YES” and “NO” for confirmation and denial.

At block S515, the terminal device determines whether the user agrees to detect the potential abnormalities. If the user agrees to detect the potential abnormalities, the user can click the “YES” button, and the procedure goes to block S516. Otherwise, the procedure is end.

At block S516, the cloud device automatically detects potential abnormalities of the terminal device. In the exemplary embodiment, the analysis module 22 asks the user to operate the terminal devices 100 in a specified way, the analysis module 22 detects potential abnormalities according to the running state of the terminal device 100 when the terminal device 100 is operated by the user. For example, the analysis module 22 asks the user to open and close the WIFI module, and detects potential abnormalities by detecting whether the WIFI module responds correctly to the user's command. If the WIFI module responds the correctly to the user's command, the analysis module 22 determines that there is not a potential abnormality. Otherwise, the analysis module 22 determines that there is a potential abnormality of the WIFI module.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A terminal device comprising:
a first communication device to communicate with a cloud device;
a first processor; and
at least one first storage device storing one or more programs, when executed by the first processor, the one or more programs cause the first processor to:
detect a running state of the terminal device and detect a process of an operation carried out by a user when the user operates the terminal device;
transmit the running state of the terminal device and the process of the operation carried out by the user to the cloud device to cause the cloud device to determine whether an abnormality occurs in the terminal device and generate an analysis report if the cloud device determines that the abnormality occurs in the terminal device;
receive the analysis report from the cloud device, the analysis report comprising a suggestion for fixing the abnormality and/or a program for fixing the abnormality; and
fix the abnormality according to the analysis report.

2. The terminal device of claim 1, wherein the first processor detects the running state of the terminal device and the process of the operation carried out by the user by detecting a running state of at least one interior component of the terminal device and an operation process of the user on the at least one interior component of the terminal device, the at least one interior component is selected from a group consisting of a touch screen, a sensor, applications, operating systems, function modules, and physical buttons.

3. The terminal device of claim 1, wherein the first processor records the running state of the terminal device and the operation process of the user in a log file.

4. The terminal device of claim 1, wherein the first processor stores the running state of the terminal device and the operation process of a most recent period.

5. The terminal device of claim 1, further comprising a display device, wherein the processor receives a prompt message from the cloud device, and controls the display device to display the prompt message, the prompt message is to prompt the user to confirm whether the abnormality is a misreading.

6. A cloud device comprising:
a second communication device to communicate with a terminal device;
a second processor; and
at least one second storage device storing one or more programs, when executed by the second processor, the one or more programs cause the second processor to:
acquire a running state of the terminal device and a process of an operation carried out by a user when the user operates the terminal device;
determine whether an abnormality occurs in the terminal device by analyzing the running state of the terminal device and the process of the operation carried out by the user;
generate an analysis report if the cloud device determines that the abnormality occurs in the terminal device, the analysis report comprising a suggestion for fixing the abnormality and/or a program for fixing the abnormality; and
transmit the analysis report to the terminal device.

7. The cloud device of claim 6, wherein the one or more programs further cause the second processor to: generate a prompt message to prompt the user to confirm whether the abnormality is a misreading, transmit the prompt message to the terminal device, and receive a confirm information from the terminal device; if the confirm information indicating that the abnormality is in fact an abnormality, the second processor generates the analysis report.

8. The cloud device of claim 6, wherein the one or more programs further cause the second processor to: collect the process of the operation carried out by the user to obtain operational habits of the user, and optimize the terminal device according to the operational habits of the user.

9. The cloud device of claim 6, wherein the one or more programs further cause the second processor to: automatically detect potential abnormalities of the terminal device.

10. The cloud device of claim 9, wherein before detecting the potential abnormality of the terminal device, the second processor generates a detecting prompt and transmit the detecting prompt to the terminal device to prompt the user to determine whether to detect the potential abnormality of the terminal device, and detects the potential abnormality of the terminal device if the user determines to detect the potential abnormality.

11. A method for handling abnormalities applied in a terminal device and a cloud device, the terminal device communicating with the cloud device, the method comprising:
detecting, by the terminal device, a running state of the terminal device and a process of an operation carried out by a user of the terminal device, and transmitting the running state and the process of the operation carried out by the user to the cloud device;
acquiring, by the cloud device, the running state of the terminal device and the process of the operation from the terminal device, and determining whether an abnormality occurs in the terminal device by analyzing the running state of the terminal device and the process of the operation carried out by the user;
generating, by the cloud device, an analysis report if the cloud device determines that the abnormality occurs in the terminal device and transmitting the analysis report to the terminal device, the analysis report comprising a suggestion for fixing the abnormality and/or a program for fixing the abnormality; and
fixing the abnormality according to the analysis report by the terminal device.

12. The method for handling abnormalities of claim 11, further comprising:
generating a prompt message, by the cloud device, to prompt the user to confirm whether the abnormality is a misreading when the cloud device determines that the abnormality occurs in the terminal device;
transmitting the prompt message to the terminal device;
displaying a prompt window by the terminal device to display the prompt message;
receiving a confirm information from the user by the terminal device;
generating the analysis report by the cloud device if the confirm information indicates that the abnormality is in fact an abnormality; and
storing the running state of the terminal device and the process of the operation carried out by the user if the abnormality is a misreading.

13. The method for handling abnormalities of claim 11, further comprising:
collecting the process of the operation carried out by the user to obtain operational habits of the user, and optimizing the terminal device according to the operational habits of the user.

14. The method for handling abnormalities of claim 11, further comprising: automatically detecting potential abnormalities of the terminal device.

15. The method for handling abnormalities of claim 14, further comprising:
generating a detecting prompt and transmitting the detecting prompt to the terminal device to prompt the user to determine whether to detect the potential abnormality of the terminal device; and
detecting the potential abnormality of the terminal device if the user determines to detect the potential abnormality.
